(19) United States
(12) Patent Application Publication
(10) Pub. No.: US 2016/0180262 A1
(43) Pub. Date: Jun. 23, 2016

(54) SYSTEM AND METHOD FOR TESTING ENTERPRISE TRANSACTIONS

(71) Applicants: Tom Brauer, Speyer (DE); Keith Sanderson, Heidelberg (DE)

(72) Inventors: Tom Brauer, Speyer (DE); Keith Sanderson, Heidelberg (DE)

(21) Appl. No.: 14/579,952

(22) Filed: Dec. 22, 2014

(51) Int. Cl. G06Q 10/06

(52) U.S. Cl. CPC G06Q 10/063

(57) ABSTRACT

A system and a method for testing enterprise transactions involve receiving test definitions at a computer and executing a test of at least one transaction involving a plurality of computer devices in an enterprise environment. The test applies the definitions as input to the computer devices. Test results are analyzed to identify a test parameter for refining the test definitions. A value of the identified parameter is changed and the test re-executed using the changed value.

### FIELD OF THE INVENTION

The present invention relates to computer implemented testing of operations within an enterprise system.

### BACKGROUND INFORMATION

Enterprise systems often include a network of computers that cooperate to perform various business-to-business (B2B) or business-to-consumer (B2C) functions enterprise resource planning (ERP), customer relationship management (CRM) and convergent charging (CC). Enterprise systems can include components running on different platforms or software applications written in different programming languages written in different programming languages such as Advanced Business Application Programming (ABAP), Java or C++. Enterprise systems may perform numerous types of transactions in regard to the above mentioned functions including, for example, point-of-sale, billing and invoicing, or supply chain management transactions. Therefore, designing, troubleshooting or modifying an enterprise system potentially requires investigating the performance of many different components and their various transactions.

Manual testing in complex system landscapes can be very time-consuming and difficult. For example, in order to test a process involving more than one system (e.g. an ERP system together with a CRM system and a non-ABAP system), a human tester needs to know about each of the systems. The typical tester may not have this knowledge and thus cannot construct meaningful tests without prior training. Another way to test business transactions is through computer executed test scripts that are manually created. However, improving such test scripts is very time-consuming and difficult due to the complexity of the various system components.

Accordingly, a need exists for an enterprise testing system that enables testing with little or no user involvement. Further, a need exists for ways to improve the test making ability of human testers without requiring the testers to learn extensively about each of the systems beforehand.

### SUMMARY

Example embodiments of the present invention relate to a system and method for testing enterprise transactions. In an example embodiment a testing system obtains preconfigured test definitions, which are applied to automatically test the basic functionality of a specific transaction or a group of related transactions.

In an example embodiment, the testing system is configured to automatically modify preconfigured test definitions to perform additional tests on a specific transaction or a group of related transactions.

In an example embodiment, the testing system includes a graphical interface that displays preconfigured test definitions together with corresponding test results and suggestions for follow up testing.

In an example embodiment, a method for testing enterprise transactions involves receiving test definitions at a computer; executing a test of at least one transaction involving a plurality of computer devices in an enterprise environment, wherein the test applies the test definitions as input to the computer devices; analyzing a result of the test to identify a test parameter for refining the test definitions; changing a value of the identified parameter; and re-executing the test using the changed value.

In an example embodiment, a system for testing enterprise transactions includes a plurality of computer devices in an enterprise environment; and a testing module receiving test definitions, wherein the testing module is configured to: execute a test of at least one transaction involving the computer devices, and wherein the test applies the test definitions as input to the computer devices; analyze a result of the test to identify a test parameter for refining the test definitions; change a value of the identified parameter; and re-execute the test using the changed value.

### DESCRIPTION OF THE DRAWINGS

FIG. 1 is a block diagram of a system for testing enterprise transactions according to an example embodiment of the present invention.

FIG. 2 is a block diagram of a database storing test definitions according to an example embodiment of the present invention.

FIG. 3 is a diagram showing a hierarchy of business entities.

FIG. 4 is a table summarizing business rules for the entities in FIG. 3.

FIG. 5 is a graphical interface showing a mapping of test parameters from an enterprise system to a testing system according to an example embodiment of the present invention.

FIG. 6 is a flowchart of a method for testing enterprise transactions according to an example embodiment of the present invention.

FIG. 6B is a graphical interface showing testable scenarios according to an example embodiment of the present invention.

FIG. 7 is a graphical interface showing details of a test script according to an example embodiment of the present invention.

FIG. 8 is a graphical interface for maintaining test scenarios according to an example embodiment of the present invention.

FIG. 9 is a graphical interface for maintaining processes for a particular test scenario according to an example embodiment of the present invention.

FIG. 10 is a graphical interface showing steps in a master data creation process of a B2B scenario according to an example embodiment of the present invention.

FIG. 11 is a graphical interface showing steps in a master agreement enhancement process according to an example embodiment of the present invention.

FIG. 12 is a graphical interface showing an overview of supplemental agreements to a master agreement according to an example embodiment of the present invention.

FIG. 13 is a graphical interface showing configurable parameters in a usage creation process according to an example embodiment of the present invention.

FIG. 14 is a graphical interface showing configurable parameters in a billing and invoicing process according to an example embodiment of the present invention

FIG. 15 is a graphical interface showing a confirmation that master data was successfully created.

FIG. 16 is a graphical interface showing a summary of test results according to an example embodiment of the present invention.

### DETAILED DESCRIPTION

Example embodiments of the present invention relate to a system and method for testing enterprise transactions. However, the example embodiments are also applicable to non-enterprise environments. Any system that can be modeled using computer executed transactions can be tested accordingly.

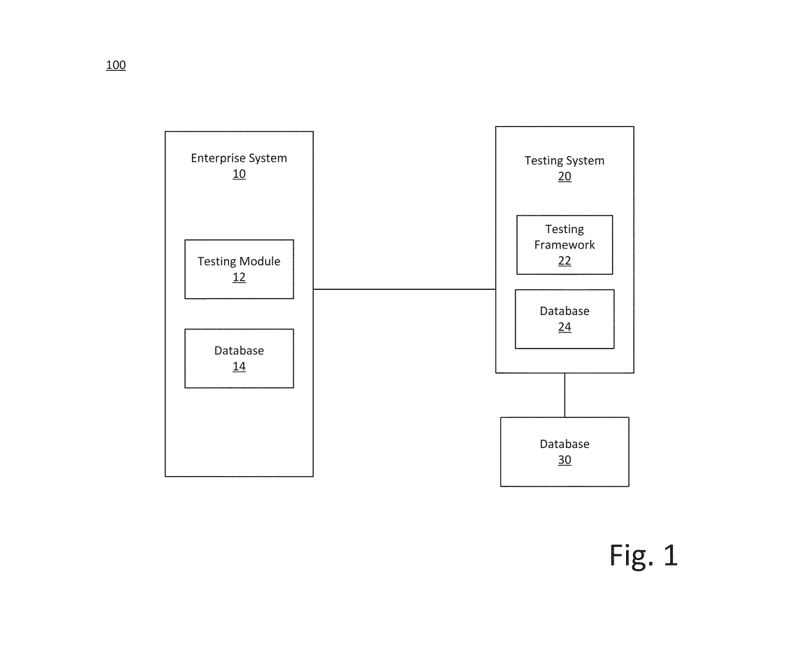

FIG. 1 shows a system 100 for testing enterprise transactions according to an example embodiment of the present invention. The system 100 may include an enterprise system 10 and a testing system 20. The enterprise system 10 may include computing devices that form multiple sub-systems (e.g., ERP, CC or CRM systems) to support the business functions of one or more business entities. For example, the enterprise system 10 may include computers which communicate with backend data servers to access business relevant information such as product inventory, customer profiles and billing records. For simplicity, these computing components and their associated sub-systems are not shown.

The enterprise system 10 may include a testing module 12 and a database 14. The testing module 12 may be implemented in hardware and/or software and coordinates with the testing system 20 to execute automated test scripts. The module 12 may also include a user interface that enables manual configuration of test scripts.

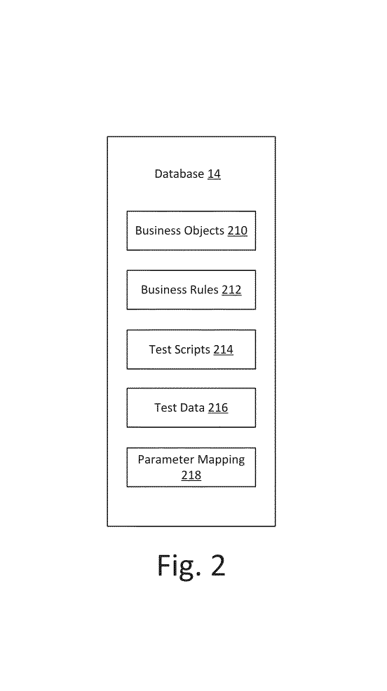

The database 14 stores test relevant data including, for example, test definitions. FIG. 2 shows details of the database 14, which may include business objects 210, business rules 212, test scripts 214, test data 216 and parameter mapping information 218. The latter components 214, 216 and 218 may together form test definitions. The former components 210 and 212 may include data that models transactions in the enterprise system.

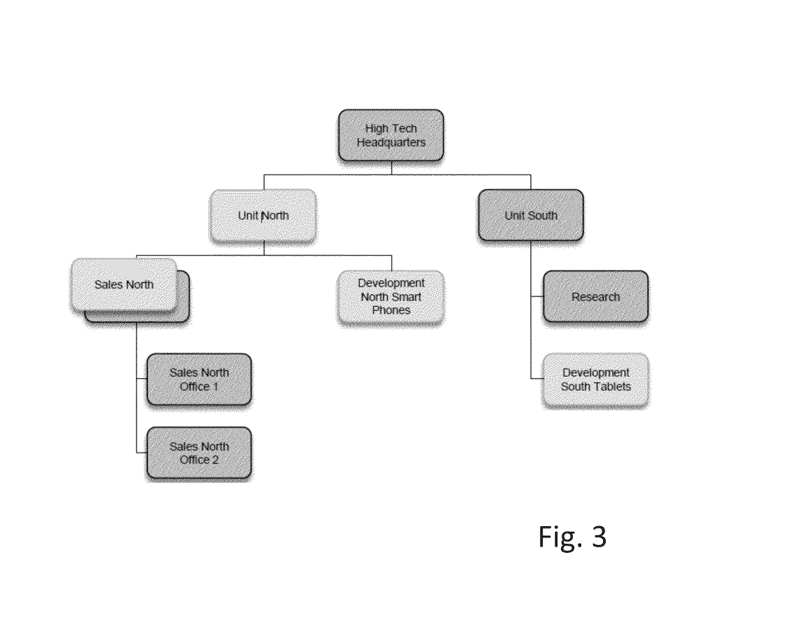

The business objects 210 may include data representing different entities (e.g., a company, a customer, a business partner, an employee, etc.). Objects may also represent products or services and may include a multitude of quantifiable parameters. Business objects may be linked to each other. For example, FIG. 3 shows a business hierarchy in which the objects are different groups within a business organization.

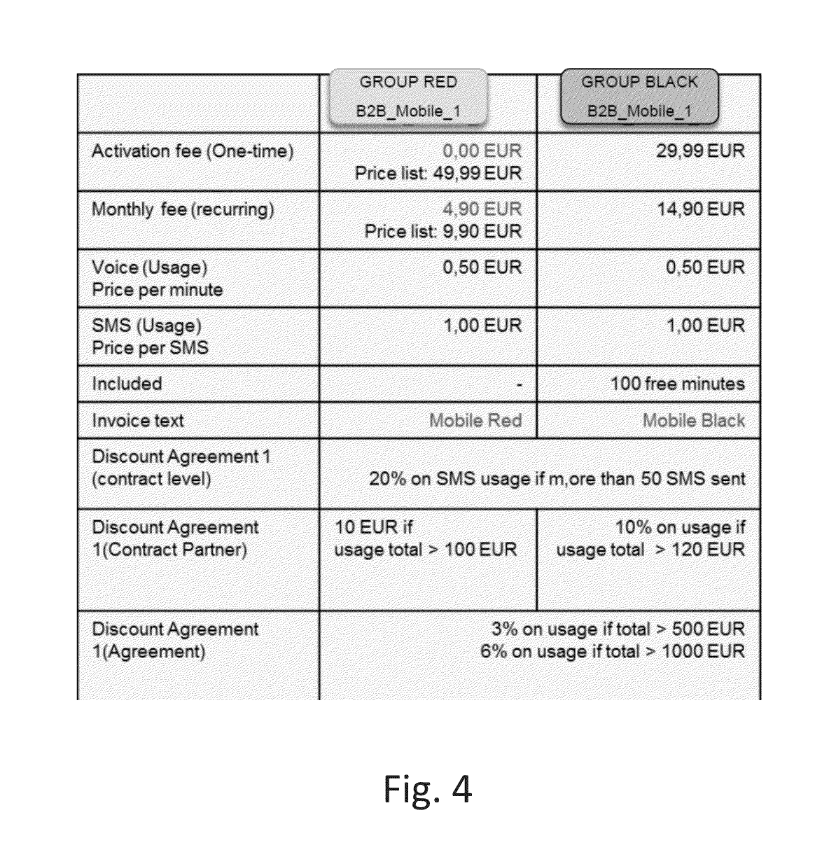

The business rules 212 may codify agreements between business entities. For example, FIG. 4 is a table summarizing a set of rules concerning mobile telephone agreements negotiated between a voice/text service provider and the organization in FIG. 3. In FIG. 4, “GROUP RED” includes Unit North, Sales North, Development North Smart Phone and Development South Tablets. “GROUP BLACK” includes High Tech Headquarters, Unit South, Research, Sales North Office 1 and Sales North Office 2. GROUP RED has a separate agreement from GROUP BLACK, as reflected in differences between, for example, activation fees and month fees. FIG. 4 also shows that agreements may be subject to other agreements. For example, there may be agreements for discounted billing, conditioned on how many text (SMS) messages are sent in total for a group or on a threshold amount of voice usage. The Business rules 212 may codify such agreements as software algorithms.

Returning to FIG. 2, the test scripts 214 may include computer files with commands that reference specific transactions and/or input to those transactions, e.g., business objects and data that triggers business rules. Rule triggering data may be included in the test data 216. An example of data that may trigger the rules illustrated in the table of FIG. 4 is usage data describing how much voice or text message usage occurred for a particular entity. The test data 216 may include actual data collected in the course of business, but are more often mock data whose values are designed to test specific rules or transactions. Accordingly, test data 216 may include values that are uncommon or not possible to achieve during actual system operation. The test scripts 214 may be read and executed by the testing system 20.

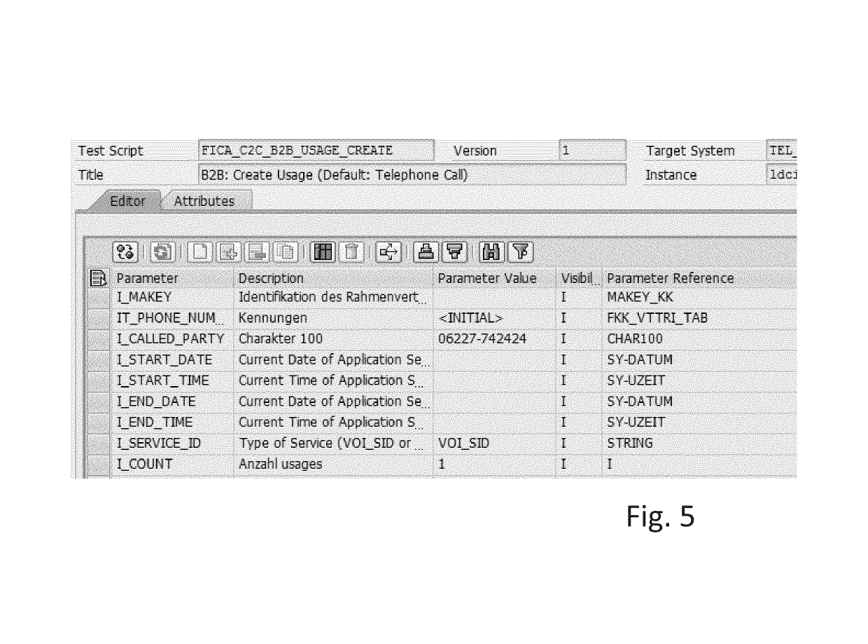

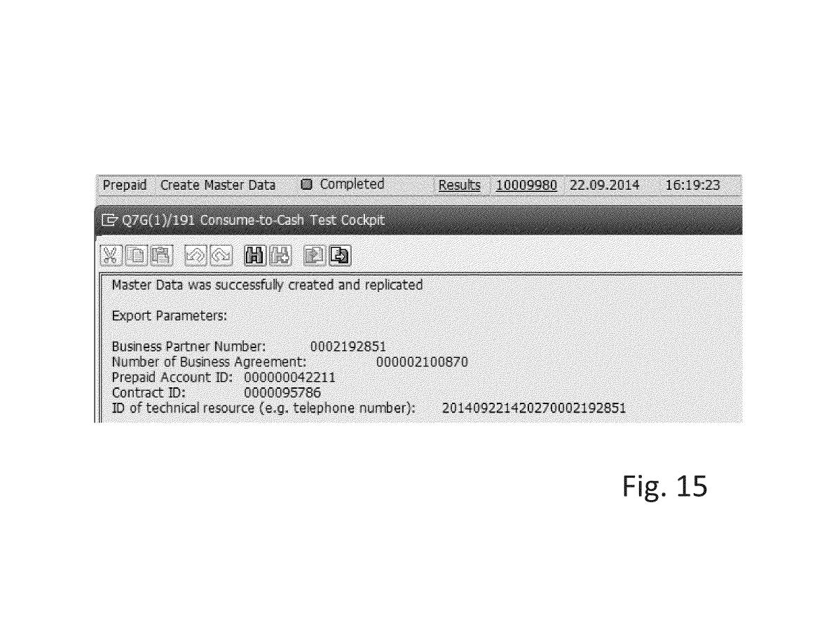

The parameter mapping information 218 may store a mapping from parameters in the enterprise system 10 to corresponding parameters in the testing system 20. FIG. 5 is a graphical interface showing an example mapping. Parameters, descriptions of the parameters, values of the parameters (which may correspond to actual data and/or mock data) and references to corresponding parameters in the testing system 20 are shown in separate columns. Parameters may include rule triggering data. For example, FIG. 15 includes a parameter “I_Count” whose value may correspond to an amount of time spent during a particular voice call between entities.

The testing system 20 may include a testing framework 22 and a local database 24. Although shown as a separate system, the testing system 20 may, in some embodiments, be the same enterprise system as the system 10. For example, both systems 10, 20 may be components of the same ERP system. The testing framework 22 executes the test scripts within the actual system landscape, e.g., by interfacing with CC, CRM and ERP components that process the test data. In an example embodiment, the testing framework 22 includes an extended Computer Aided Test Tool (eCATT) module that parses test scripts supplied by the testing module 12 to execute tests. Test results may be stored locally in the database 24 and/or an external database 30, e.g., on a Cloud server.

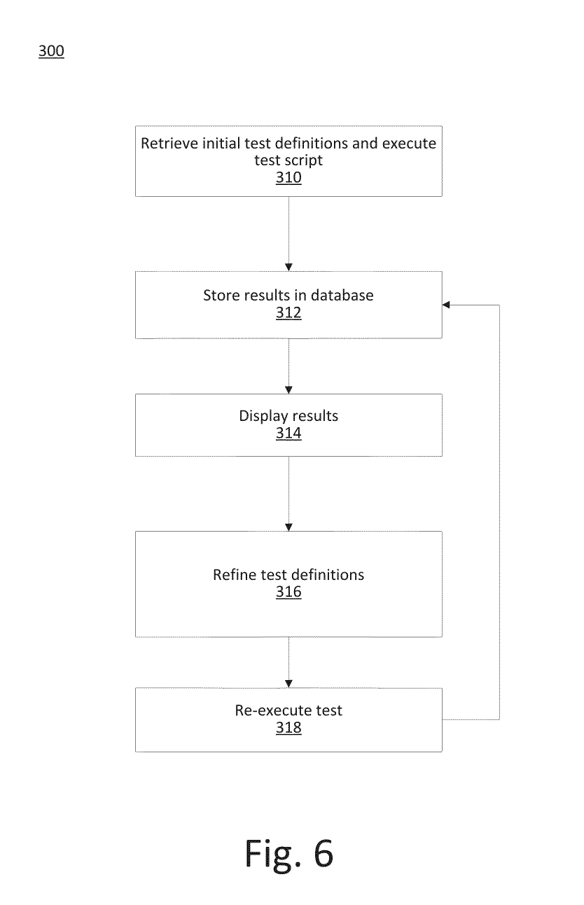

FIG. 6 is a flowchart of a method 300 for testing enterprise transactions according to an example embodiment of the present invention. The method 300 may be performed at the system 100. At step 310, the testing module 12 retrieves initial test definitions and calls the testing system 20 to execute an automated test script using the initial definitions, which may be designed to test a basic functionality of a business scenario by, for example, applying predefined test data to test whether a particular transaction is executed successfully. The automated test may, as an alternative to retrieving predefined test data, involve automatically creating a new set of test data, for example, each time the automated test is executed. One way in which the testing module 12 may create new test data is to obtain valid data ranges for each parameter involved in the test and select, for the initial test, a median value of each parameter or some other starting value.

At step 312, the test results are stored in a database, e.g., in the database 24 or 30.

At step 314, the testing module 12 may retrieve and display the test results through a graphical interface.

At step 316, the testing module 12 refines the test definitions by, for example, changing the value of one or more parameters. The testing module 12 may be programmed to perform the refinement in an iterative manner, e.g., by selecting new values for testing in accordance with a predefined sequence. As an example, the testing module 12 may, after testing a median value, select an upper limit or a lower limit for testing. The testing module 12 may include logic to determine which of a plurality of parameters will be modified for further testing. If, for example, the test results indicate that a transaction or group of related transactions were executed without error or resulting values were within expected ranges, the testing module 12 may forego further testing of the parameters involved in those transactions. If, however, there was an error that prevented the transaction or group of related transactions from executing to completion or the transaction(s) returned an unexpected value, the testing module 12 may select one or more involved parameters to be modified for further testing. In one embodiment, the testing module 12 may be programmed to, when an error is recognized, repeat the test by varying one parameter at a time to determine, by process of elimination, which parameters may be contributing to an error or unexpected value.

In one embodiment, the testing module 12 may refrain from directly modifying parameters without manual confirmation from a human tester. In such instances, the testing module 12 may output suggestions for which parameters to modify and what values might be worth testing. The tester may learn from these suggestions and from the test results provided in step 314 to improve on the automated test. For example, the tester may, through viewing the test results, detect errors that the testing module 12 missed. The testing module 12 may allow the tester to freely modify the values.

At step 318, the testing module 12 calls the testing system 20 to re-execute the test using the modified test definitions. The test may be repeated until the testing module 12 and/or the tester is satisfied with the results. The testing module may discontinue testing if, for example, the error or unexpected value is no longer present in the results, after a certain number of repetitions, or after testing a certain range of values.

Example graphical interfaces for testing enterprise transactions will now be described. The graphical interfaces may be output by the testing module 12 and are meant to show what options are available to a human tester interacting with the testing module 12. However, it will be understood that the various options shown may be equally available to the testing module 12 itself

FIG. 6B is a graphical interface 50 showing testable scenarios according to an example embodiment of the present invention. The interface 50 enables a tester to expand on predefined business scenarios by adding new scenarios and specifying what processes are involved in those new scenarios. The scenarios may be displayed in a menu 52 and include, for example, Prepaid, Postpaid, B2B, Data Migration, B2C Discount and Partner Settlement scenarios. Each scenario may be assigned to a separate tab and may involve one or more processes, where each process includes at least one transaction. Examples of processes in a Prepaid scenario include creating master data (e.g., business objects and business rules codifying agreements between entities), refilling a prepaid account, creating usage data (e.g., details of mock telephone calls or text messages) and billing/invoicing. Each process may include corresponding test data.

The interface 50 may include a list of executed tests 54. The list shows, for example, which tests were executed on a particular date and may include links to test results. The list 54 may show a status of a test performed for a particular process (e.g., completed, failed, started or paused). The interface 50 may also include a section 56 with options to specify details for a selected scenario or an individual process within a selected scenario.

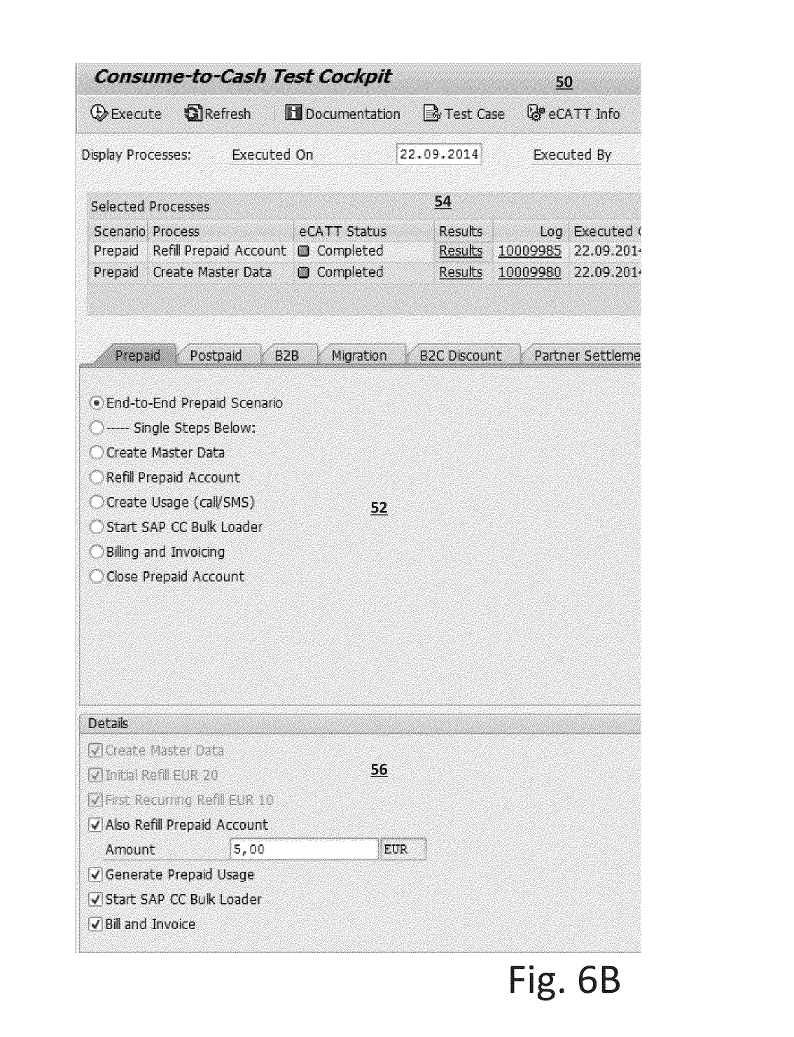

FIG. 7 is a graphical interface showing details of a test script according to an example embodiment of the present invention. FIG. 7 corresponds to a single test configuration and includes a description of the test (e.g., Consume-to-Cash), one or more transaction codes (e.g., an ABAP transaction code), an indication of whether the test is performed manually or automatically, an identifier of the test script that executes the test (e.g., a name of an eCATT test script), settings relating to communications between the enterprise system 10 and the testing system 20 (e.g., Remote Function Call (RFC) connections, and settings that define an option to trigger a specific function module (e.g., adding an option to trigger an SAP CC module within the interface 50.

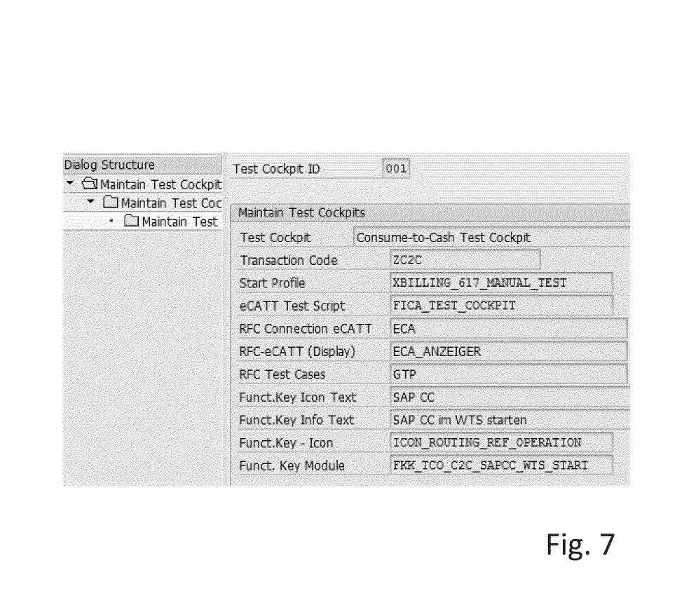

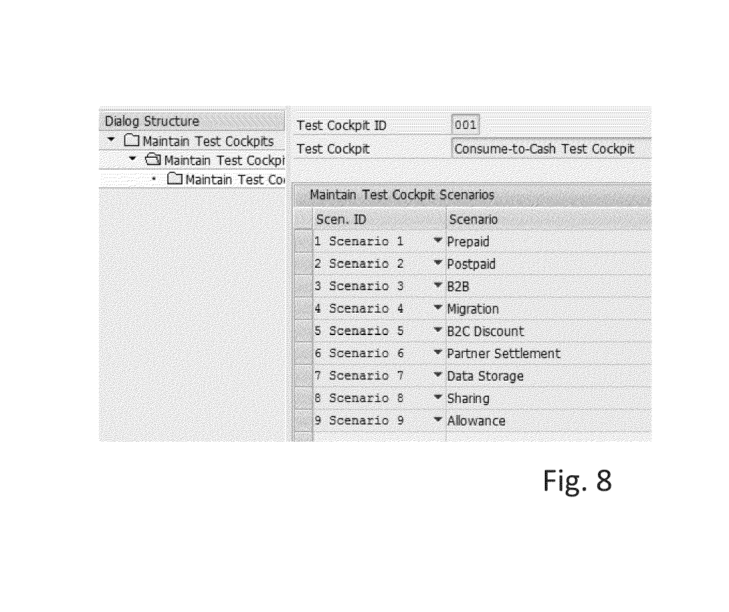

FIG. 8 is graphical interface for maintaining test scenarios. Each scenario may include an associated identifier and corresponds to a scenario in FIG. 6B. Scenarios may be added, deleted and customized Similarly, the processes within a particular scenario may be added, deleted or customized FIG. 9 is a graphical interface showing testable processes for a Prepaid scenario.

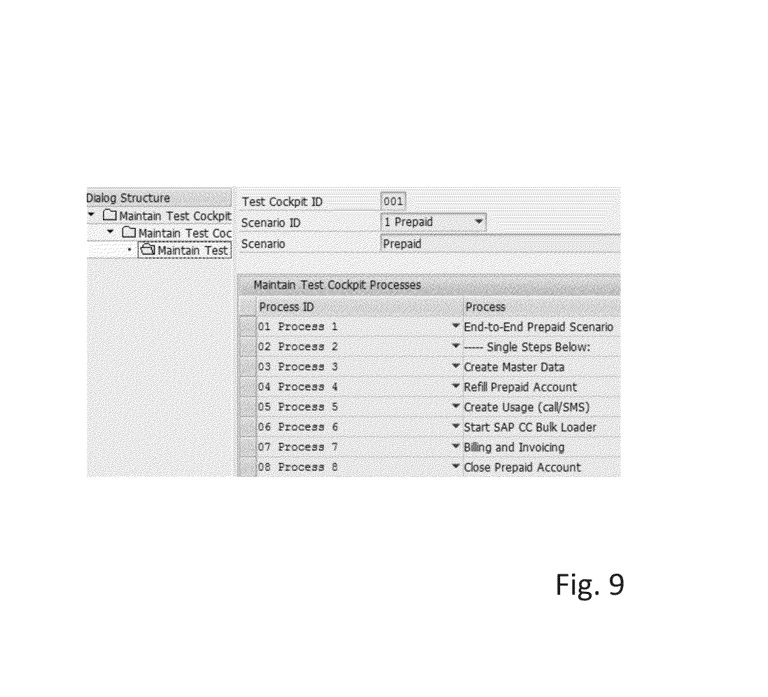

FIG. 10 is a graphical interface showing steps in a master data creation process of a B2B scenario according to an example embodiment of the present invention. The steps may include creating a business partner hierarchy such as the one shown in FIG. 3, creating a master agreement, releasing a master agreement for testing, and creating a provider contract in reference to the master agreement. As mentioned earlier, such agreements may be codified as business rules. The testing module 12 may output a confirmation after each step is executed, e.g., a confirmation including a message that the master data was successfully created together with an identifier of a master agreement.

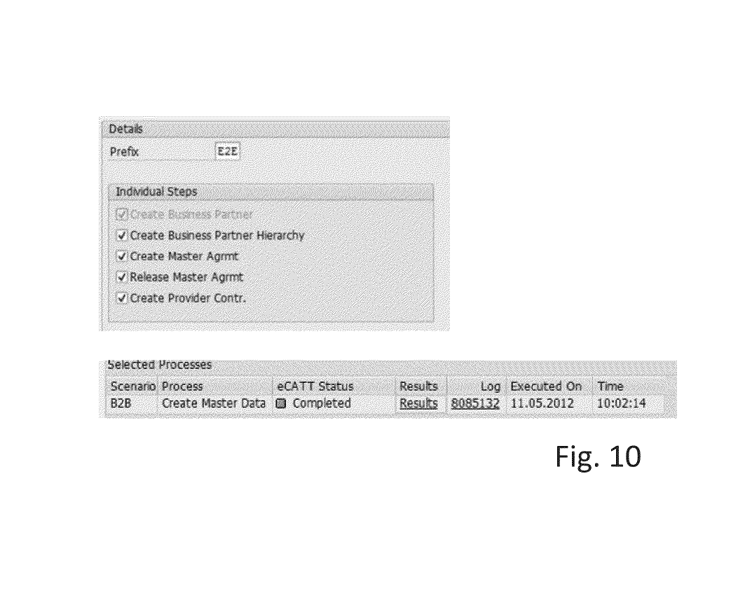

FIG. 11 is a graphical interface showing steps in a master agreement enhancement process. The steps reference a specific master agreement and may include a specific date from which supplemental agreements that modify the master agreement are valid. These additional agreements may relate to, for example, invoices, an invoicing list and discounts. Usage data may be created to test whether rules codifying a master agreement or a supplemental agreement are properly enforced. For example, if an agreement requires application of a certain billing rate or discount rate, but the rate is not applied or applied to produce an unexpected billing amount, this may indicate that the rules are not being enforced or enforced incorrectly by one or more components in the enterprise system. The testing module may confirm whether a rule isn't being enforced by, as with any other type of error, re-testing using modified test parameters.

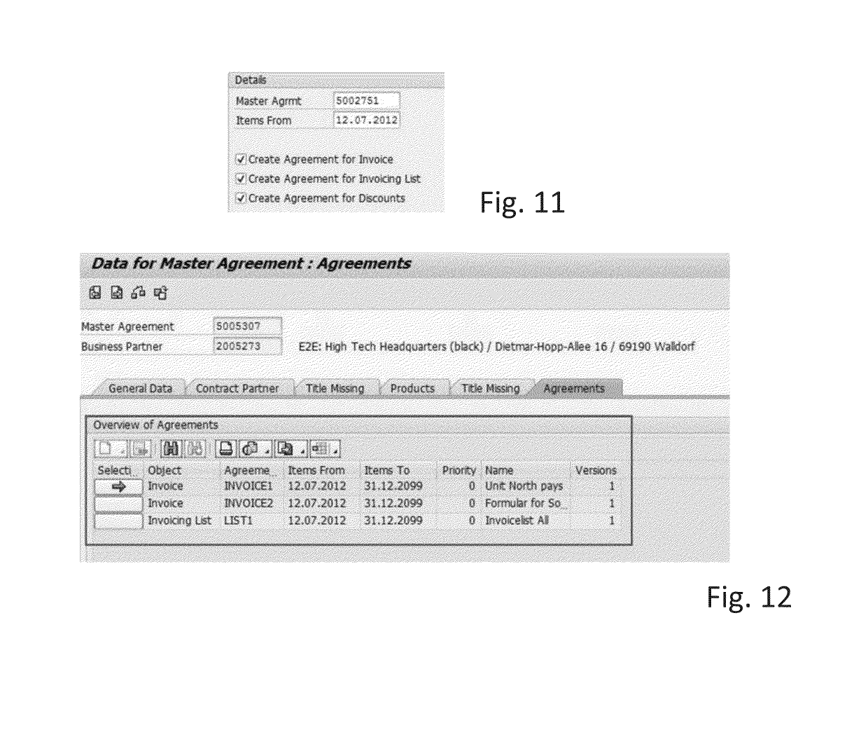

FIG. 12 is a graphical interface showing an overview of supplemental agreements that modify a particular master agreement, with a particular business partner.

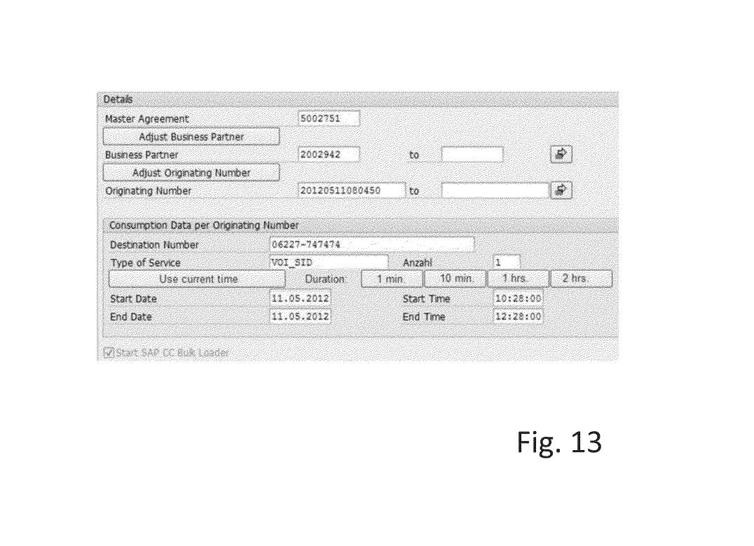

FIG. 13 is a graphical interface showing configurable parameters relating to a usage creation process. The options shown in FIG. 13 may be used to specify details of a mock call or voice message for use as test data, and may include a reference to a particular master agreement or a particular business partner, an originating number (e.g., a caller's telephone number), a destination number, service type (e.g., VOI_SID refers to voice calls), a usage duration, a start date/time, and an end date/time. If information entered is actual data rather than mock data, the data may be sent to a CC system for direct processing.

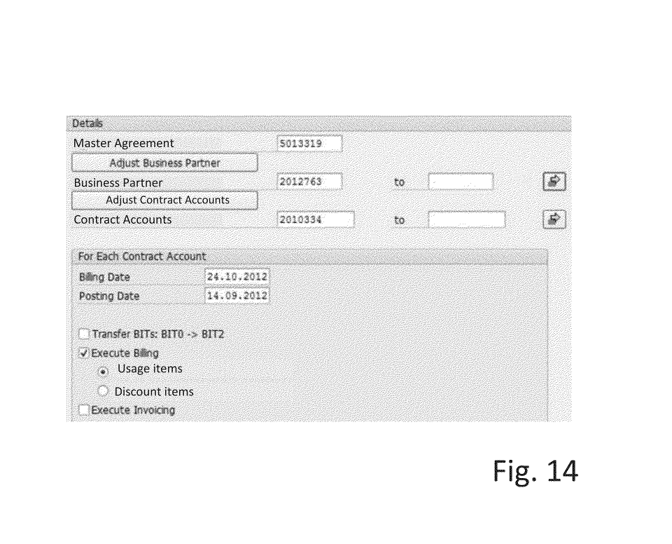

FIG. 14 is a graphical interface showing configurable parameters relating to a billing and invoicing process. The options shown in FIG. 14 may be used to create a bill or invoice for a particular business partner, under a particular master agreement, for a particular billing date, and for a particular contract account. By default, all business partners involved in the identified master agreement and all their corresponding contract accounts may be selected. Billing or invoicing may be executed for usage items and/or discount items (e.g., by applying usage data created according to FIG. 13).

FIG. 15 is a graphical interface showing a confirmation that master data was successfully created.

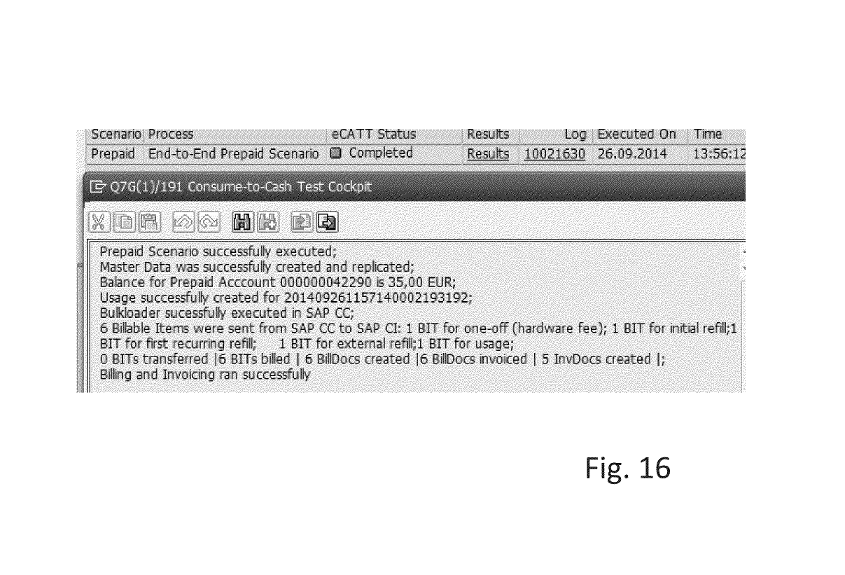

FIG. 16 is a graphical interface showing a summary of example test results. The summary may include messages indicating whether test data (e.g., master data or usage data) was created successfully, whether test processes executed successfully, and a description of the transactions that occurred between different system components (e.g., how many billable items were sent from a Convergent Charging component to a Convergent Invoicing component). In this manner, the interface may describe the end-to-end flow of data in a tested process or scenario.

Automated testing may be performed by the overall system under one of two modes. The first mode is a fully automated mode in which the testing module triggers execution of automated test scripts to perform prerequisite steps in a larger overall testing process. Usage data creation and master data creation are examples of prerequisite steps. The second mode is also automated, but involves applying test data (e.g, master data and/or usage data) to perform a more involved test that invokes the actual functions of the system components. The results of this functional test can be made available to a human tester so that the test definitions may be manually configured if desired.

In an example embodiment, every test may include in its results an error flag and a status message containing information about whether the steps in the test were successful or not. When performing a test that involves multiple processes, error flags and status messages from earlier processes may be incorporated into later processes. For example, B2B master data creation may be a prerequisite step for a test of B2B usage creation, so that any error flags or status messages encountered during testing of B2B master data creation can be incorporated into the error flags/status messages of a subsequent B2B usage creation test.

In an example embodiment, the testing module 12 may be configured so that it does not detect, or does not perform follow-up testing in response to, errors beyond those that clearly result in unsuccessful execution. This is useful for educating and/or assessing the skill level of the human tester. As an example, suppose a set of master data was successfully created, but a business partner was mistakenly excluded. The exclusion of the business partner may not be a critical error, so the testing module 12 may simply report the success of the data creation, allowing this set of data to be used in subsequent tests in the hope that the human tester will recognize the error and correct the test definitions accordingly. Alternatively, the testing module 12 may output a message hinting that there is an error, possibly providing clues as to the nature of the error, but without revealing the exact error. Thus, the example embodiments may enable improvements in tester skill through application of automated tests, in addition to improvement of automated tests as a result of improvements in tester skill.

An example embodiment of the present invention is directed to one or more processors, which can be implemented using any conventional processing circuit and device or combination thereof, e.g., a CPU of a Personal Computer (PC) or a mobile computer or other workstation processor, to execute code provided, e.g., on a hardware computer-readable medium including any conventional memory device, to perform any of the methods described herein, alone or in combination. The one or more processors can be embodied in a server or user terminal or combination thereof. The user terminal can be embodied, for example, as a desktop, laptop, hand-held device, Personal Digital Assistant (PDA), television set-top Internet appliance, mobile telephone, smart phone, etc., or as a combination of one or more thereof The memory device can include any conventional permanent and/or temporary memory circuits or combination thereof, a non-exhaustive list of which includes Random Access Memory (RAM), Read Only Memory (ROM), Compact Disks (CD), Digital Versatile Disk (DVD), and magnetic tape.

An example embodiment of the present invention is directed to a non-transitory, hardware computer-readable medium, e.g., as described above, on which are stored instructions executable by a processor to perform any one or more of the methods described herein.

An example embodiment of the present invention is directed to a method, e.g., of a hardware component or machine, of transmitting instructions executable by a processor to perform any one or more of the methods described herein.

The above description is intended to be illustrative, and not restrictive. Those skilled in the art can appreciate from the foregoing description that the present invention may be implemented in a variety of forms, and that the various embodiments can be implemented alone or in combination. Therefore, while the embodiments of the present invention have been described in connection with particular examples thereof, the true scope of the embodiments and/or methods of the present invention should not be so limited since other modifications will become apparent to the skilled practitioner upon a study of the drawings and specification. Further, steps illustrated in the flowcharts may be omitted and/or certain step sequences may be altered, and, in certain instances multiple illustrated steps may be simultaneously performed.

What is claimed is:

1. A method for testing enterprise transactions, comprising:
receiving test definitions at a computer;
executing a test of at least one transaction involving a plurality of computer devices in an enterprise environment, wherein the test applies the test definitions as input to the computer devices;
analyzing a result of the test to identify a test parameter for refining the test definitions;
changing a value of the identified parameter; and
re-executing the test using the changed value.

2. The method of claim 1, wherein the plurality of computer devices form at least two of the following: an enterprise resource planning (ERP) system, a customer relationship management (CRM) system, a convergent charging (CC) system and a converging invoicing (CI) system; and
wherein the at least one transaction involves a communication between the at least two systems.

3. The method of claim 2, further comprising:
outputting an end-to-end description of data flow that occurred during the communication between the at least two systems.

4. The method of claim 1, wherein the parameter is identified by detecting an error in the test result and selecting from a set of parameters that potentially contributed to the error. The method of claim 1, further comprising:
forming an initial set of test definitions based on business rules that codify an agreement between business entities.

6. The method of claim 5, further comprising:
changing the value of the identified parameter to test whether a rule codifying the agreement is properly enforced.

7. The method of claim 5, further comprising:
outputting an indication of whether the initial set of test definitions was formed successfully.

8. The method of claim 5, further comprising:
forming usage data that triggers one of the rules.

9. The method of claim 5, further comprising:
specifying, in the test definitions, a particular business entity and a particular agreement to which the test is applied.

10. The method of claim 1, further comprising:
mapping test parameters in the test definitions to corresponding parameters in an extended Computer Aided Test Tool (eCATT) module.

11. A system for testing enterprise transactions, comprising:
a plurality of computer devices in an enterprise environment; and
a testing module receiving test definitions, wherein the testing module is configured to:
execute a test of at least one transaction involving the computer devices, and wherein the test applies the test definitions as input to the computer devices;
analyze a result of the test to identify a test parameter for refining the test definitions;
change a value of the identified parameter; and
re-execute the test using the changed value.

12. The system of claim 11, wherein the plurality of computer devices form at least two of the following: an enterprise resource planning (ERP) system, a customer relationship management (CRM) system a convergent charging (CC) system and a converging invoicing (CI) system; and
wherein the at least one transaction involves a communication between the at least two systems.

13. The system of claim 12, wherein the testing module outputs an end-to-end description of data flow that occurred during the communication between the at least two systems.

14. The system of claim 11, wherein the testing module identifies the parameter by detecting an error in the test result and selecting from a set of parameters that potentially contributed to the error.

15. The system of claim 11, wherein the testing module forms an initial set of test definitions based on business rules that codify an agreement between business entities.

16. The system of claim 15, wherein the testing module changes the value of the identified parameter to test whether a rule codifying the agreement is properly enforced.

17. The system of claim 15, wherein the testing module outputs an indication of whether the initial set of test definitions was formed successfully.

18. The system of claim 15, wherein the testing module forms usage data that triggers one of the rules.

19. The system of claim 15, wherein the testing module specifies, in the test definitions, a particular business entity and a particular agreement to which the test is applied.

20. The system of claim 11, wherein the testing module maps test parameters in the test definitions to corresponding parameters in an extended Computer Aided Test Tool (eCATT) module.
